(19) United States
(12) Patent Application Publication
(10) Pub. No.: US 2016/0207809 A9
(43) Pub. Date: Jul. 21, 2016

(54) Self-Regenerating Zeolite Reactor for Sustainable Ammonium Removal

(71) Applicant: ROBERT SPENCER COLLISON, Vacaville, CA (US)

(72) Inventor: ROBERT SPENCER COLLISON, Vacaville, CA (US)

(21) Appl. No.: 14/093,491

(22) Filed: Dec. 1, 2013

Related U.S. Application Data
(60) Provisional application No. 61/738,441, filed on Dec. 18, 2012.

(51) Int. Cl. C02F 3/30; B01J 49/00

(52) U.S. Cl. CPC C02F 3/307; B01J 49/0091

(57) ABSTRACT

A method of using micro-organisms to continuously and sustainably regenerate zeolite cation exchange capacity (CEC) for removing nitrogen (ammonium, nitrite, and nitrate) from wastewater. The zeolite immobilizes the ammonium ions, and the micro-organisms ingest the ammonium from the surface of the zeolite thereby freeing the cation exchange sites to trap more ammonium. The zeolite is continuously regenerated by the microbes, sustainably maintaining available ion exchange capacity for removing ammonium, and does not need to be shut down for regeneration or replacement. The microbial complex contains nitrifiers, anammox, denitrifiers, archaea, and others. All the micro-organisms co-exist in the same reactor promoting symbiotic interactions, thereby increasing treatment efficiency. The end product is di-nitrogen gas which dissipates into the atmosphere. The system does not require aeration, operates by gravity flow, and has very low energy requirements. Maintenance is minimal, and the system can significantly reduce greenhouse gas emissions (nitrous oxide).

Notes: This document uses the terms ammonia and ammonium interchangeably, just as the compounds themselves are interchangeable (NH3+H⁺ [symbol] NH4⁺). In aquatic systems ammonia (NH3) is predominantly found in the ionic form as ammonium (NH4).

### CROSS REFERENCES TO RELATED APPLICATIONS

This application claims the benefit of provisional patent application No. 61/738,441, filing date Dec. 18, 2012.

### STATEMENT REGARDING FEDERALLY SPONSORED RESEARCH

Not applicable

### THE NAMES OF THE PARTIES TO A JOINT RESEARCH AGREEMENT Not applicable.

### REFERENCE TO A COMPACT DISC

Not applicable

### BACKGROUND OF THE INVENTION

Conventional wastewater treatment of nitrogen (consisting primarily of ammonium and nitrate) uses the twin processes of nitrification to transform ammonium to nitrate, and then the separate denitrification process to transform nitrate to di-nitrogen gas. These processes require two completely different sets of environmental conditions and infrastructures; can use large amounts of energy; may utilize significant quantities of chemicals such as methanol; and require skilled maintenance. The combined construction, operation, and maintenance impacts have resulted in high economic costs. In addition to economic considerations, there are significant environmental impacts associated with the current level of treatment. Nitrate pollution attributed to sewage, fertilizers, and industrial processes has caused widespread environmental damage on a global scale, including some severe societal impacts.

Ammonium removal by zeolite has been used commercially for over 30 years, and ammonium immobilization by zeolite is well documented and highly effective. The process was never popular, however, because of the need to periodically shut down the system to either remove and replace the zeolite, or to artificially regenerate the zeolite (by brine, air-stripping, etc). Traditional zeolite systems merely removed ammonium from solution, and further processes were required to convert it to nitrate or di-nitrogen gas.

The present invention is radically different because the microbial activity ensures the zeolite never becomes saturated and is therefore continually available to keep immobilizing ammonium. The system converts the ammonium to an end product of di-nitrogen gas which is released to the atmosphere. The system is a sustainable bio-zeolite reactor, running at full functionality at all times.

1. Field of the Invention

The present invention is in the field of wastewater treatment. More particularly, the present invention is in the field of nitrogen nutrient removal (ammonium, nitrite and nitrate).

2. Description of Prior Art

U.S. Pat. No. 4,098,690: Describes a process using ion exchange to reduce ammonia content of wastewaters. However the ion exchanger becomes saturated and has to be regenerated by concentrated salt solution and nitrifying bacteria. This requires the process to be shut down for regeneration, and the end-product is nitrate (a pollutant).

U.S. Pat. No. 4,522,727: Describes a process for removing ammoniacal nitrogen from aquaculture systems using zeolite. However the zeolite becomes saturated and has to be regenerated by heating to between 350° C. and 650° C. to strip ammonia. This requires the process to be shut down and the zeolite dried, heated, and re-generated, requiring significant energy.

U.S. Pat. No. 6,080,314: Describes a process using zeolite to remove nitrogen contaminants from septic systems. However the zeolite becomes exhausted and has to be regenerated by cations to displace the ammonia, or by heating, or by nitrifying bacteria. This requires the process to be shut down for regeneration, and the end-product is nitrate (a pollutant), or ammonia gas released by heating processes requiring significant energy.

U.S. Pat. No. 7,452,468: Describes a process of intermittent or continuous feeding of suspended zeolite powder to increase surface area, in conjunction with unspecified biological material. Zeolite volume is fed at ratio of 20 parts per million compared to system volume, and can increase bacterial residence time, nitrification, denitrification and carbonaceous processes. However this process is a performance enhancer for malfunctioning existing systems, not a stand-alone treatment system, not a fixed film zeolite reactor, and does not contain anammox.

### REFERENCES

Van de Graaf A. A., A. Mulder, P. de Bruijn, M. S. M. Jetten, L. A. Robertson, J. G. Kuenen. 1995. Anaerobic oxidation of ammonium is a biologically mediated process. Applied and Environmental Microbiology, April 1995, 1246-1251.

Van Dongen U., M. S. M. Jetten, M. C. M. van Loosdrecht. 2001. The Sharon-Anammox process for treatment of ammonium rich wastewater. Water Science and Technology, Vol 44 No 1, 153-160.

Van der Star W. R. L., W. R. Abma, D. Blommers, J. Mulder, T. Tokutomi, M. Strous, C. Picioreanu, M. C. M. van Loosdrecht. 2007. Startup of reactors for anoxic ammonium oxidation: Experiences from the first full-scale anammox reactor in Rotterdam. Water Research, 41 (2007), 4149-4163.

### BRIEF SUMMARY OF THE INVENTION

The present invention uses zeolite media (or similar alternatives with high cation exchange capacity such as ion exchange resins or synthetic zeolites) to immobilize ammonium by cation exchange. The positively charged ammonium ions (NH4) are attracted to the zeolite because it is negatively charged. The system works with many different types of zeolite, but clinoptilolite is a good choice because it is abundant and preferentially adsorbs ammonium over most other cations. However, the choice of the media will usually be determined by the transport costs—i.e. the closest source. This invention is unique because it uses microbial activity to continually regenerate the zeolite, and forms a self-regenerating system. The micro-organisms colonize the zeolite and ingest the ammonium, thereby continually freeing up the cation exchange sites to immobilize more ammonium—forming a continuous self-sustaining cycle of regeneration.

Depending on conditions the microbial population includes primarily anammox bacteria and nitrifying bacteria, but also includes denitrifying bacteria and archaea:

Anammox—There are several genera of anammox bacteria and many different anammox species—each adapted for different ecological niches. However all anammox “eat” ammonium as their food source, combining ammonium with nitrite to produce di-nitrogen gas, water, and energy per the equation:

NH4+NO2→N2+2H2O*.

Although the combination of nitrite and ammonium is the most advantageous to anammox for energy production, anammox can also combine ammonium and nitrate to form nitrogen gas per the equation:

4NH4+4NO3→4N2+8H2O+2O2*.

(*Note: these are the simplified equations—see References for detailed equations). Examples of anammox bacteria may include, but are not limited to, the following genera: Brocadia, Kuenenia, Anammoxoglobus, Jettenia.

Nitrifiers—Nitrifying bacteria oxidize ammonium to nitrate. However this is a two step process, with nitrite as the intermediate step: NH4→NO2→NO3. The conversion of nitrite to nitrate (i.e. the second step) generally happens quickly, typically within 30 minutes). Examples of nitrifying bacteria may include, but are not limited to, the following genera: Nitrosomonas, Nitrospira, Nitrosococcus, Nitrosolobus (first stage nitrification—NH4 to NO2); and Nitrobacter, Nitrospina, Nitrococcus (second stage nitrification—NO2 to NO3).

Anammox-nitrifier symbiosis—The predominant bacterial activity is the symbiosis between the nitrifiers and the anammox. One of the key features of this invention is the establishment of an extensive oxycline (i.e. boundary between aerated and anoxic zones) allowing bacteria from different zones to exist in close proximity. The first stage of nitrification converts ammonium to nitrite (NH4→NO2). The nitrite then diffuses through the oxycline where anammox combine nitrite with more ammonium to form di-nitrogen gas and water.

Denitrifiers—If BOD is present then denitrifiers can use nitrate as an oxygen source resulting in the conversion of nitrate to nitrogen gas. The importance of denitrification is generally low in this system, but the design can be modified to enhance the role of denitrification. Examples of denitrifying bacteria may include, but are not limited to, the following genera: Thiobacillus, Micrococcus, Paracoccus, Pseudomonas.

Archaea and others—there are several species of archaea that are believed to perform a similar role to anammox, but generally at low ammonium concentrations. Archaea are not well understood or documented but will undoubtedly be present in this system, albeit at low concentrations. Examples of archaea may include, but are not limited to, the following phyla: Crenarchaeota, Euryarchaeota.

Other organisms such as fungi can be present, but they do not generally have a significant role in ammonia removal.

The invention is a green, self-sustaining treatment system with low infrastructure costs and low energy usage. The design focus is to produce a robust system with minimal maintenance requirements. Nitrogen removal can be carried out at any scale, and the process encourages reduced economic, environmental, and societal impacts.

The present invention provides a natural systemic regeneration of the zeolite, and can also directly convert the ammonium to nitrogen gas—this bypasses the conversion of ammonium to nitrate and therefore prevents nitrate pollution. The system described herein optimally has one or more of the following traits:
The system provides continuous, ongoing, biological, in-situ regeneration of the zeolite.
The system is cyclic, running continually without interruption.
The biological regeneration ensures the zeolite always has free CEC for immobilizing influent ammonium.
The excess CEC provides reserve capacity to treat influent ammonium surges.
The system requires minimal energy—it uses gravity flow (no pumping).
The ability of the zeolite to “wick up” water increases the surface area and oxygen dissolving capacity by several orders of magnitude—therefore no artificial aeration is required.
The system uses a natural biological regenerative process; it does not need to be turned on and off; it needs minimal monitoring; it is very low maintenance.
There are no odors or unpleasant smells.
The ammonium and nitrate removed by the system is converted to di-nitrogen gas and water.
The end product is di-nitrogen gas (an almost inert form of nitrogen which comprises about 78% of the atmosphere we breathe).

### BRIEF DESCRIPTION OF THE SEVERAL VIEWS OF THE DRAWINGS

FIG. 1 is a plan view of the system.

FIG. 2 is a side elevation/cross sectional view of the system.

FIG. 3 is a side elevation of the zeolite media submerged in water.

### DETAILED DESCRIPTION OF THE INVENTION

This invention provides in one instance a system for biologically regenerating zeolite in-situ such that the process is continuous and sustainable, and may run indefinitely without the need for artificial regeneration. The zeolite has two main functions—firstly it immobilizes ammonium ions by cation exchange therefore providing a food source for ammonia-eating bacteria; secondly the ability of zeolite to “wick up” water provides sufficient aeration to oxidize the ammonia optimally, with or without additional or artificial aeration.

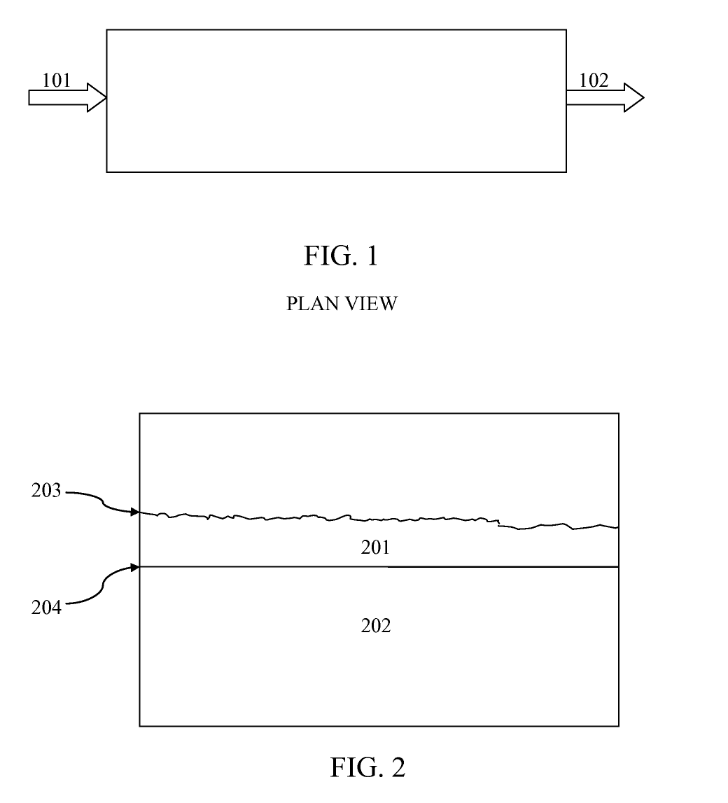

FIG. 1 is a plan view of the system showing a flat bed zeolite reactor in a tank, pond, or any enclosure containing both water and zeolite. The polluted influent 101 enters at one end of the system, and the treated effluent 102 discharges from the other end. The influent percolates slowly through the zeolite media, and the zeolite traps the ammonium at the cation exchange sites. Hydraulic retention times vary according to conditions, but water flowing through ¾″ zeolite in a Mediterranean climate such as Northern California can have a contact time in the order of 24 hours.

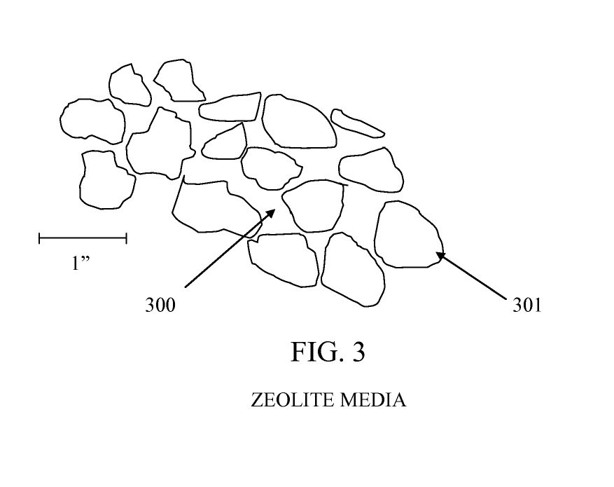

FIG. 2 is a side elevation of the system where 203 is the surface of the zeolite, and 204 is the surface of the water. 202 shows the submerged layer of zeolite which is predominantly anaerobic or anoxic. 201 is the zeolite layer above the water surface, and approximately one inch (depending on media size) of the zeolite layer above the water surface is completely saturated with water due to the “wicking” effect, and is also fully aerated. This means that the water surface area available for dissolving oxygen is significantly greater than the surface area of just water calculated by length multiplied by width. Because of the additional surface area the system the system has sufficient dissolved oxygen to oxidize ammonium without artificial aeration.

FIG. 3 is a side elevation showing the submerged zeolite media. Each piece of zeolite 301 has an irregular surface colonized by bacteria. In between the pieces of zeolite are water-filled pore spaces 300 through which water can flow and ammonium can diffuse. The zeolite is single sized media with no fines, since the fines will impede or block water flow. The size of the media can range from large sand (0.1″) thru pea gravel (0.35″), drain rock (0.75″), coarse drain rock (1.5″) to gabion stone (3″). The size is governed by the desired flow and the surface area requirements. Larger media particles provide larger pores for water flow but correspondingly less surface area for microbial colonization.

The system is set up to provide an environment to encourage the growth of anammox bacteria; high concentrations of nitrifiers and anammox will likely provide the most efficient treatment method. Although the system can work with just nitrifiers and denitrifiers (under high BOD loadings the denitrification process could become significant), the system would continue to function as designed. In most situations, however, the anammox will outcompete the denitrifiers in this system, but both forms of bacteria will be present regardless of which type predominates.

The “action layer” of the system is the oxycline between aerated 201 and non-aerated 202 layers.

Nitrifiers and anammox are in close proximity on their respective sides of the oxycline, enabling some of the nitrite produced by the first stage of nitrification to be used by the anammox before it is converted to nitrate. In this situation the anammox are competing with the second stage denitrifiers for the nitrite, and the more nitrite used by anammox the more efficient system. Below the action layer in the anaerobic/anoxic zone 202 is an environment containing minimal oxygen, where anammox combine ammonium with either nitrite or nitrate that diffuses or percolates down from the action layer. The lower part of the submerged layer 202 serves as an anaerobic polishing layer, as a repository of sludge & particulate matter, and as a water reservoir if the surface level varies through irregular flows etc.

What is claimed is:

1. A method for removing total nitrogen (TN), or ammonium, from waste water or any freshwater or brackish aquatic medium, using a zeolite-anammox reactor consisting of bio-zeolite comprising:
a) a physico-biological process predominated by a cationic exchange medium, such as zeolite, and a biological component containing anammox;
b) a combination of zeolite and anammox to form a continuously running, self-regulating, self-regenerating zeolite-anammox treatment system for removing TN;
c) a combination of zeolite and a microbial mixture forming bio-zeolite,
d) bio-zeolite as a permanent, stratified, fixed film cation exchange reactor for nitrogen species removal including continuous ongoing in-situ biological regeneration of zeolite (i.e. does not require shutting down for regeneration);
e) options include a low energy system that can run by gravity flow and atmospheric aeration.

2. A method according to claim 1 including the use of a cation exchange medium, such as zeolite, to immobilize the ammonium.

3. A method according to claim 2 including selecting nominally single-sized zeolite sufficient for water to flow through horizontally or vertically through the reactor.

4. A method according to claim 1 for providing a biological system for re-generating the cation exchange (e.g. zeolite) sites by ingestion, comprising:
a) a microbial cocktail growing on the zeolite surface and ingesting the ammonium;
b) the biological oxidation of ammonium to nitrite (and sometimes nitrate) by nitrifying bacteria;
c) a microbial cocktail including anammox bacteria to reduce nitrate to nitrite by dissimilatory nitrate reduction, as required;
d) a microbial cocktail including nitrifying bacteria in symbiosis with anammox bacteria;
e) a microbial cocktail including anammox bacteria to combine ammonium and nitrite;
f) a process utilizing anammox (and sometimes archaea) to convert ammonium and nitrite to nitrogen gas and water.

5. A method according to claim 4 for converting ammonia directly to nitrogen gas at a single location or infrastucture.

6. A method according to claim 4 wherein the microbial organisms include combinations of anammox bacteria, nitrifying bacteria, and denitrifying bacteria; and archaea.

7. A method according to claim 1 for aerobic and anaerobic bacteria inhabiting adjacent stratified layers providing for nitrite production and ingestion, respectively.

8. A method according to claim 6 whereby the zeolite reactor is a non-aerated flat bed system approximately 6″ deep containing stratified layers.

9. A method according to claim 8 wherein the water surface elevation is controlled such that the surface of the zeolite is above the water surface.

10. A method according to claim 9 wherein the zeolite's proclivity to “wick” water provides a wetted layer of zeolite above the surface of the water, significantly increasing the surface area for the water to dissolve atmospheric oxygen, and providing sufficient dissolved oxygen for the system to oxidize ammonium without needing artificial aeration.

11. A method according to claim 6 whereby the zeolite reactor is an aerated system in a tank or container, constructed as a downward flow system with stratified layers, and with the anaerobic layer below.

12. A method according to claim 1 providing ammonium treatment in the following wastewater effluent streams:
i) Mainstream with typical ammonium concentrations between 3 mg/L and 100 mg/L;
ii) Primary mainstream with BOD concentrations between 20 mg/L and 100 mg/L;
iii) Secondary mainstream with BOD concentrations between 2 mg/L and 10 mg/L;
iv) Side-stream with ammonium concentrations between 500 mg/L and 3000 mg/L.
